(19) United States
(12) Patent Application Publication
(10) Pub. No.: US 2015/0060715 A1
(43) Pub. Date: Mar. 5, 2015

(54) Gate Valve Seal Ring

(71) Applicant: Cameron International Corporation, Houston, TX (US)

(72) Inventor: Loc Gia Hoang, Houston, TX (US)

(21) Appl. No.: 14/013,956

(22) Filed: Aug. 29, 2013

(51) Int. Cl. F16K 3/02

(52) U.S. Cl. CPC F16K 3/0227
USPC 251/328

(57) ABSTRACT

Embodiments of the present disclosure are directed toward a gate valve seal ring comprising a seat holder comprising a recess and a seat ring disposed within the recess, wherein the seat ring comprises a corrosion resistant and wear resistant material.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In certain applications, a structure (e.g., a wireline or tubing) may obstruct closure of a valve, such as a gate valve. Under certain conditions, it may be desirable to cut the wireline or tubing to enable closure of the valve while retaining the valve's sealing integrity over an extended period of use.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic diagram of an exemplary gate valve having seal rings, in accordance with embodiments of the present disclosure;

FIG. 2 is a cross-sectional schematic diagram of a seal ring, in accordance with embodiments of the present disclosure;

FIG. 3 is a cross-sectional schematic diagram of a seal ring, in accordance with embodiments of the present disclosure;

FIG. 4 is a cross-sectional, schematic diagram of a seal ring, in accordance with embodiments of the present disclosure; and

FIG. 5 is a cut away perspective view, taken along line 5-5 of FIG. 4, of a seal ring, in accordance with embodiments of the present disclosure.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The following disclosure relates to an exemplary improved seal ring that has a seat ring supported by a seat holder. That seat ring may be formed from a hard, corrosion resistant material, such as metals, metal alloys, ceramics, ceramic metals (i.e., cermets), or any combination thereof, for example. Particular examples of a hard, corrosion resistant material are Stellite™ (e.g., cobalt-based alloys and/or cobalt-chromium alloys), tungsten carbide, stainless steel, carbides, nitrides, or other material designed for corrosion resistance and/or wear resistance. Moreover, the Stellite™ may include cobalt, nickel, iron, aluminum, boron, carbon, chromium, manganese, molybdenum, phosphorus, sulfur, silicon, titanium, or any combination thereof.

The seat ring may be retained within the seat holder by a seal, such as an O-ring, a shrink fit material and/or method, a snap-fit, threads, an interference fit, or other retaining material and/or method. In certain embodiments, the seat ring may be formed from an existing seal ring. For example, an existing seal ring (e.g., a previously used seal ring) may be machined or modified to form the seat holder mentioned above. Thereafter, the seat holder may be fitted with the seat ring, and the seat ring may be retained within the seat holder by a sealing material, a shrink fit material and/or method, a snap-fit, an interference fit, or other retaining material and/or method. In this manner, existing or previously used (e.g., previously used in the field) seal rings may be re-used, refurbished, recycled, or otherwise improved, thereby reducing costs associated with manufacturing and/or maintaining gate valves.

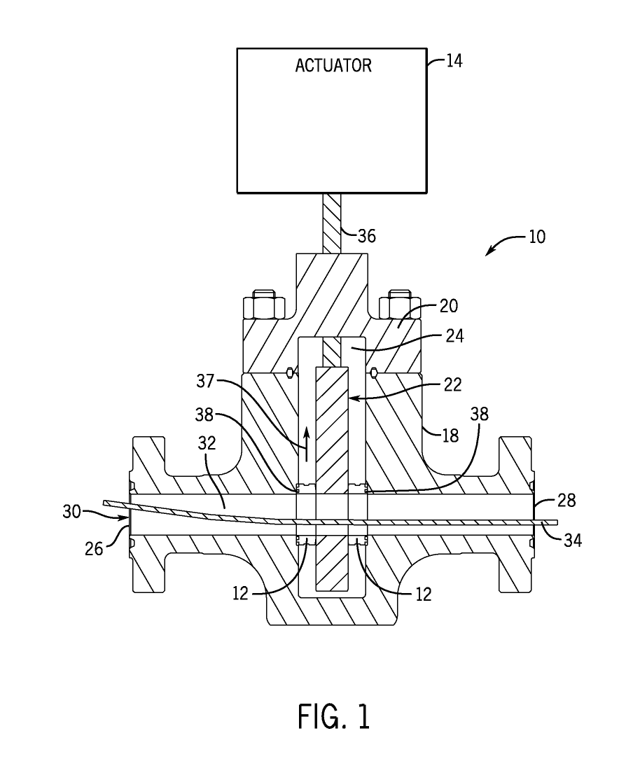

FIG. 1 illustrates an embodiment of a gate valve 10 having improved seal rings 12. The gate valve 10 is generally configured to control a flow of fluid in various applications. For example, the gate valve 10 may be employed in applications relating to oil and gas industries, power generation industries, petrochemical industries, and the like. In oilfield applications, the gate valve 10 may be coupled to a Christmas tree (not shown) that controls the extraction of production fluid from a well. The gate valve 10 has a bore (e.g., bore 30) that may be sized for the given application. For example, the bore of the gate valve 10 may be at least approximately 3 inches in diameter. In other embodiments, the gate valve 10 includes a smaller bore that may be less than approximately 5 inches. In certain embodiments, the gate valve 10 is configured to operate at a high pressure of at least approximately 10,000 pounds per square inch (psi). In some embodiments, the gate valve 10 is configured to operate at pressure lower than approximately 10,000 psi. Additionally, in certain embodiments, the gate valve 10 may be used to shear a wireline, coil tubing, or other obstruction. That is, the gate valve 10 may be configured to apply a shearing force to break the obstruction and allow for travel of a gate 22.

In the illustrated embodiment, the gate valve 10 includes an actuator 14. The actuator 14 may be coupled to a top portion of a valve body 18 via a bonnet 20, or the actuator 14 can be directly coupled to the valve body 18. The body 18 may be constructed of cast iron, ductile iron, cast carbon steel, gun metal, stainless steel, alloy steels, corrosion resistant alloys, and/or forged steels. The gate valve 10 includes a gate 22 disposed within a cavity 24 of the body 18. As will be appreciated, the gate 22 is configured to move (e.g., axially translate) between an open position and a closed position within the cavity 24. As illustrated, the gate 22 is disposed in the open position. In certain embodiments, the gate 22 has a rectangular cross-sectional profile. The body 18 of the gate valve 10 includes an inlet 26 and an outlet 28 configured for a flow of a fluid through a bore 30 of the body 18 into a passage 32 of the gate valve 10. In certain embodiments, the outlet 28 may act as an inlet allowing fluid flow into the passage 32 from either side of the gate valve 10. For example, in some embodiments, the inlet 26 may act as an outlet and the outlet 28 may act as an inlet.

Additionally, as mentioned above, the gate valve 10 may be configured to shear a wireline, coil tubing, or other tubular member. In the illustrated embodiment, a wireline 34 extends through the bore 30 and the passage 32 of the body 18 of the gate valve 10. When the gate 22 of the gate valve 10 moves (e.g., axially translates) from an opened position to a closed position, the gate 22 shears the wireline 34, thus allowing the gate 22 to close without removing the obstruction, here the wireline 34.

In the illustrated gate valve 10, the actuator 14 provides the motive force to open and close the valve 10. In particular, the actuator 14 applies a force (e.g., a linear axial force) to a stem 36 coupling the gate 22 to the actuator 14. In this manner, the gate 22 moves (e.g., in an axial direction 37) from the open position shown in the illustrated embodiment to a closed position. For example, the actuator 14 may include a spring, a hydraulic piston, a manually actuated mechanism (e.g., hand wheel), or other actuation system (e.g., spring-biased actuator, electrical actuator, magnetic actuator, or any combination thereof)

As the gate 22 moves (e.g., axially translates) from the open position to the closed position, the wireline 34 is sheared against the improved seal rings 12. These seal rings 12 include a seat ring supported by a seat holder. The seat ring may be formed from a hard, corrosion resistant material, examples of which have been discussed above.

As shown, each of the improved seal rings 12 is disposed in a respective recess 38 formed in the body 18 of the gate valve 10. More specifically, one improved seal ring 12 is disposed on an upstream side of the gate 22 in the respective recess 38, and another improved seal ring 12 is disposed on a downstream side of the gate 22 in the respective recess 38. The improved seal rings 12 may each include one or more seals (e.g., spring-loaded lip seals) disposed between the respective recess 38 of the body 18 and the improved seal ring 12. Additionally, each improved seal ring 12 may include a seat holder that supports a seat ring. More specifically, the seat ring may be formed from a hard, corrosion resistant material designed for corrosion resistance and/or wear resistance, examples of which have been discussed above. In certain embodiments, the seat ring of each improved seal ring 12 may be replaceable, thereby reducing costs associated with maintaining, repairing, and/or replacing the improved seal rings 12. Additionally, in certain embodiments, existing seal rings may be used to form the seat holder of the improved seal ring 12. In this manner, existing seal rings may be retrofitted to form the improved seal ring 12, thereby recycling and improving existing seal rings.

FIG. 2 illustrates an embodiment of the improved seal ring 12 having a seat holder 50 supporting a seat ring 52. As mentioned above, in certain embodiments, the seat ring 52 may be formed from a cobalt-based material, such as Stellite™, or other hard, corrosion resistant material designed for corrosion resistance and/or wear resistance. For example, the seat holder 50 and the seat ring 52 may each have an annular configuration and may be disposed within an annular recess 54 formed in the seat holder 50. In other words, the seat ring 52 is an insert positioned within the recess 54 rather than a coating of the seat holder 50. As such, the whole surface of the seat holder 50 may not be coated with a corrosion resistant and/or wear resistant material. In the illustrated embodiment, the recess 54 is formed in a radially inward surface 56 of the seat holder 50 and a gate 22 (FIG. 1) facing surface 58 of the seat holder 50. The seat ring 52 is disposed and retained within the recess 54 of the seat holder 50, such that the seat holder 50 and seat ring 52 cooperatively form the annular improved seal ring 12 (FIG. 1). During operation, a gate-facing surface 60 of the seat ring 52 may abut and rub against the gate 22 (FIG. 1) of the gate valve 10 (FIG. 1). As will be appreciated, the cobalt-based material (e.g., Stellite™) used to form the seat ring 52 may be wear resistant and corrosion resistant. As a result, the seat ring 52 and the improved seal ring 12 may have improved longevity and useful life.

As mentioned above, the seat ring 52 is supported by the seat holder 50 and retained within the recess 54 of the seat holder 50. For example, in the illustrated embodiment, the seat ring 52 is retained within the recess 54 of the seat holder 50 at least partially by a seal, a lock ring, or a retaining ring 62. More specifically, the seal 62 has a face seal configuration. In other words, the seal 62 is disposed at least partially between an axial surface 64 of the recess 54 and the seat ring 52. The seal 62 is disposed at least partially between a radial surface 66 of the recess 54 and the seat ring 52. As such, the seal 62 is disposed in a corner 68 of the recess 54. In certain embodiments, the seal 62 may be an O-ring, other annular seal, or other face seal. The seal 62 operates to create an interference or friction fit between the seat holder 50 and the seat ring 52. As a result, the seat ring 52 may be retained within the recess 54 of the seat holder 50. In certain embodiments, the seat holder 50 (e.g., the radial surface 66 of the seat holder 50), the seat ring 52 (e.g., circumferential surface of the seat ring 52), and the seal 62 may be assembled to form the improved seal ring 12, and heat may be subsequently applied to the assembled improved seal ring 12 to improve (e.g., cure) the interference fit created between the seat holder 50, the seat ring 52, and the seal 62. In other embodiments, the seat holder 50, the seat ring 52, and the seal 62 may be assembled to form the improved seal ring 12 in a low temperature environment (e.g., using liquid nitrogen). After the improved seal ring 12 is assembled, the improved seal ring 12 may be removed from the low temperature environment, and as the improved seal ring 12 components (e.g., the seat holder 50, the seat ring 52, and the seal 62) increase in temperature, the interference fit created between the seat holder 50, the seat ring 52, and the seal 62 may be improved (e.g., cured).

Furthermore, in certain embodiments, the seat holder 50 may be heated and the seat ring 52 may be cooled before assembly. Heating the seat holder 50 may cause thermal expansion in the seat holder 50 and cooling the seat ring 52 may cause thermal contraction in the seat ring 52. After assembly, the seat holder 50 and the seat ring 52 may return to ambient temperature to create the interference fit to seal and/or hold between the seat holder 50 (e.g., radial surface 66 of seat holder 50) and the seat ring 52 (e.g., circumferential face of seat ring 52). In other words, the seat holder 50 may cool, thereby causing thermal contraction in the seat holder 50, and the seat ring 52 temperature may rise, thereby causing thermal expansion in the seat ring 52. In this manner, the seat holder 50 and the seat ring 52 may engage with one another to form the interference fit.

As mentioned above, the improved seal ring 12 may be formed at least partially from existing seal rings. In this manner, existing seal rings 12 may be recycled and improved to form the improved seal ring 12, thereby reducing costs associated with gate valve 10 maintenance. For example, in certain embodiments, an existing seal ring may be removed from the gate valve 10, and the existing seal ring may be used to form the seat holder 50 of the improved seal ring 12. In other words, an existing seal ring may be machined or modified to form the seat holder 50 having the recess 54 for supporting the seat ring 52. Existing seal rings may be formed from a solid metal or a metal having a coating. As such, existing seal rings may be suitable for forming the seat holder 50 of the improved seal ring 12. For example, the recess 54 may be formed by milling, grinding, turning, or other machining process. That is, an existing seal ring may undergo a machining process to create the recess 54. In this way, the exiting seal ring may be repurposed for use as the seat holder 50 of the improved seal ring 12. After the recess 54 is created, the seat ring 52 may be positioned within the recess 54 and retained by the seal 62, as described above.

In other embodiments, the seat holder 50 may be newly formed. In other words, the seat holder 50 may not be created from an existing seal ring. For example, the seat holder 50 may be cast or otherwise formed form metal to include the recess 54. After the seat holder 50 is formed, the seat ring 52 made of a material, such as a cobalt-based material or other hard, corrosion resistant and/or wear resistant material may be positioned and retained within the recess 54 to form the improved seal ring 12.

The improved seal ring 12 may include other features, such as recesses 70 configured to support seals (e.g., spring loaded lip seals) between the improved seal ring 12 and the recess 38 of the body 18 of the gate valve 10. Additionally, the illustrated embodiment of the improved seal ring 12 also includes a chamfered edge 72 formed in the gate 22 facing surface 58 of the improved seal ring 12. The chamfered edge 72 may improve installation and translation of the improved seal ring 12 between the body 18 and the gate 22 of the gate valve 10.

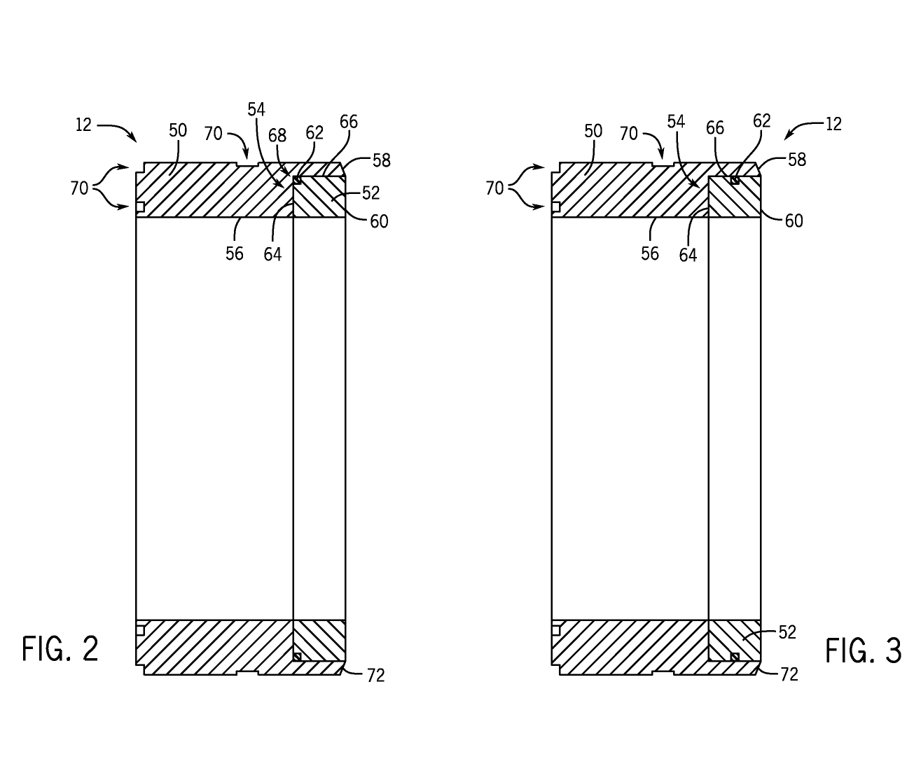

FIG. 3 illustrates an embodiment of the improved seal ring 12 having the seat holder 50 supporting the seat ring 52. As mentioned above, the seat ring 52 is formed from a material, such as a hard, corrosion resistant material (e.g., Stellite™ or other cobalt-based material). As similarly discussed above, in the illustrated embodiment, the seat ring 52 is retained within the recess 54 of the seat holder 50 by the seal 62 (e.g., O-ring). However, in the illustrated embodiment, the seal 62 has a radial configuration. That is, the seal 62 (e.g., annular seal) is positioned between the radial surface 66 of the recess 54 and the seat ring 52. As discussed in detail above, the seal 62 may create an interference or friction fit between the seat holder 50 and the seat ring 52, thereby retaining the seat ring 52 within the recess 54.

FIG. 4 illustrates an embodiment of the improved seal ring 12 having the seat holder 50 supporting the seat ring 52. As mentioned above, the seat ring 52 is formed from a hard, corrosion resistant and/or wear resistant material, such as Stellite™ or other cobalt-based material. In the illustrated embodiment, the seat ring 52 is retained within the recess 54 of the seat holder 50 by a shrink fit material 100. Specifically, the shrink fit material 100 is positioned between the seat ring 52 and the radial surface 66 of the recess 54. However, in other embodiments, the shrink fit material 100 may also be positioned between the axial surface 64 of the recess 54 and the seat ring 52.

As similarly described above with respect to the seal 62, the shrink fit material 100 creates an interference fit between the seat holder 50 and the seat ring 52. As will be appreciated, the interference fit may be created by the shrink fit material 100 upon the heating or cooling of the shrink fit material 100 after the seat holder 50, the seat ring 52, and the shrink fit material 100 are assembled to form the improved seal ring 12. For example, after the seat holder 50, the seat ring 52, and the shrink fit material 100 are assembled, heat may be applied to the shrink fit material 100 to cause the shrink fit material 100 to expand between the seat holder 50 and the seat ring 52. Furthermore, during assembly of the improved seat ring 12, the shrink fit material 100 may be cooled to cause thermal contraction of the shrink fit material 100. Thereafter, when the shrink fit material 100 returns to ambient temperature, the shrink fit material 100 may expand to create an interference fit between the seat holder 50 and the seat ring 52, thereby retaining the seat ring 52 within the recess 54 of the seat holder 50.

In certain embodiments, the shrink fit material 100 may be a sleeve or have an annular configuration, such that the shrink fit material 100 fits around a circumference of the seat ring 52. In other embodiments, multiple, non-continuous pieces of shrink fit material 100 may be positioned between the seat ring 52 and the seat holder 50 during assembly of the improved seal ring 12.

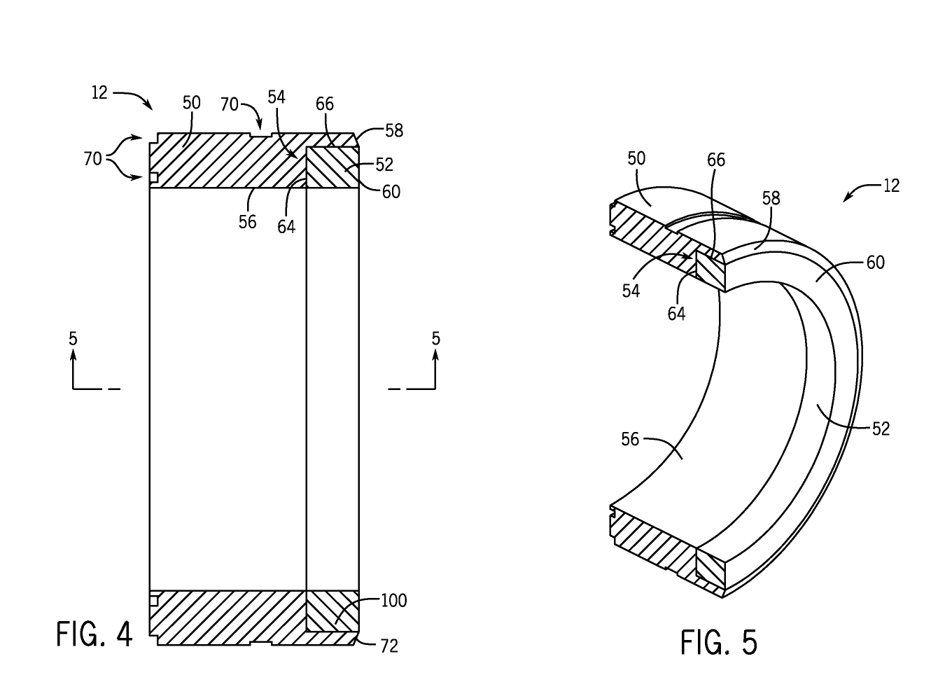

FIG. 5 is a partial cut away perspective view, taken along line 5-5 of FIG. 4, of an embodiment of the improved seal ring 12 having the seat ring 52 retained within the recess 54 of the seat holder 50. As shown, the seat ring 52 and the seat holder 50 each have an annular configuration. As discussed in detail above, the seat ring 52 may be retained within the recess 54 of the seat holder 50 by created in interference fit between the seat ring 52 and the seat holder 50. For example, the seal 62 (FIG. 3) and/or the shrink fit material 100 may be positioned between the seat ring 52 and the seat holder 50 to generate the interference fit between the seat ring 52 and the seat holder 50.

As discussed above, in certain embodiments, the seat holder 50 of the improved seat ring 12 may be created by recycling an existing seat ring. That is, an existing seat ring may be machined to formed the recess 54 therein, and the existing seat ring with the recess 54 may serve as the seat holder 50. In this manner, existing seat rings may be recycled and repurposed to form the improved seat ring 12, thereby reducing costs associated with improving and/or maintaining the gate valve 10. Furthermore, in certain embodiments, the seat ring 52 of the improved seal ring 12 may be replaceable. As such, the seat holder 50 may be reused and the seat ring 52 may be replaced as desired, thereby reducing costs associated with maintaining the improved seal ring 12. For example, the seat ring 52 may be removed from the recess 54 and replaced with a newer seat ring 52.

Embodiments of the present disclosure include the improved seal ring 12 for the gate valve 10. More specifically, the improved seal ring 12 includes the seat ring 52 supported by the seat holder 50. For example, as discussed in detail above, the seat ring 52 may be formed from a hard, corrosion resistant and/or wear resistant material, such as Stellite™, other cobalt-based alloy, or other alloy designed for wear resistance. The seat ring 52 may be retained within the seat holder 50 by the seal 62, such as an O-ring, the shrink fit material 100, and/or other retaining material. In certain embodiments, the improved seal ring 12 may be formed from an existing seal ring. For example, an existing seal ring may be machined or modified by form the seat holder 50. Thereafter, the seat holder 50 may be fitted with the seat ring 52, and the seat ring 52 may be retained within the seat holder 50 by a sealing material (e.g., seal 62), a shrink fit material (e.g., shrink fit material 100), or other retaining material. In this manner, existing seal rings may be re-used, refurbished, recycled, or otherwise improved, to form the improved seal ring 12, thereby reducing costs associated with manufacturing and/or maintaining gate valves 10.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A gate valve seal ring, comprising:
a seat holder comprising a recess; and
a seat ring disposed within the recess, wherein the seat ring comprises a corrosion resistant and wear resistant material.

2. The gate valve seal ring of claim 1, wherein the corrosion resistant and wear resistant material is a cobalt-based material.

3. The gate valve seal ring of claim 1, wherein the seat ring is retained within the recess with an interference fit between the seat ring and the seat holder.

4. The gate valve seal ring of claim 3, comprising an O-ring disposed between the recess and the seat ring, wherein the O-ring is configured to create the interference fit.

5. The gate valve seal ring of claim 4, wherein the O-ring is disposed within a corner of the recess, wherein the corner is formed at the intersection of a radially inward surface of the recess and an axial surface of the recess.

6. The gate valve seal ring of claim 4, wherein the O-ring is disposed between the seat ring and a radially inward surface of the recess.

7. The gate valve seal ring of claim 3, comprising a shrink fit material disposed between the recess and the seat ring, wherein the shrink fit material is configured to create the interference fit.

8. The gate valve seal ring of claim 1, wherein the seat ring is annular.

9. The gate valve seal ring of claim 1, wherein the seat holder is formed from an existing seal ring, and the recess is machined in the existing seal ring.

10. The gate valve seal ring of claim 1, comprising a gate valve comprising a seal ring recess, wherein the gate valve seal ring is disposed within the seal ring recess.

11. A system, comprising:
a gate valve comprising a seal ring recess; and
a gate valve seal ring disposed within the seal ring recess, wherein the gate valve seal ring comprises:
a seat holder comprising a recess; and
a seat ring disposed within the recess, wherein the seat ring comprises a corrosion resistant and wear resistant material.

12. The system of claim 11, wherein the corrosion resistant and wear resistant material is a cobalt-based material.

13. The system of claim 11, wherein the seat ring is retained within the recess by an annular seal.

14. The system of claim 11, wherein the seat ring is retained within the recess by a shrink fit material.

15. The system of claim 11, wherein the seat ring is exposed to a gate facing surface of the gate valve seal ring.

16. The system of claim 11, wherein the recess is formed in a radially inward surface of the seat holder and a gate facing surface of the seat holder.

17. A gate valve, comprising:
a gate valve seal ring, comprising:
a seat holder comprising a recess, wherein the seat holder comprises a first material; and
a seat ring disposed within the recess, wherein the seat ring comprises a second material, wherein the second material is different from the first material, and the second material is corrosion resistant and/or wear resistant.

18. The gate valve of claim 17, wherein the second material is a cobalt-based alloy.

19. The gate valve of claim 17, wherein the seat ring is retained within the recess by a shrink fit material configured to create an interference fit between the seat ring and the seat holder.

20. The gate valve of claim 17, wherein seat holder is formed from a previously used seal ring, and the recess is machined into the previously used seal ring.
